(19) United States
(12) Patent Application Publication
(10) Pub. No.: US 2026/0194182 A1
(43) Pub. Date: Jul. 9, 2026

(54) Secure and Customizable Enclosure for a Video Doorbell

(71) Applicant: Doorbell Guard, LLC, Marco Island, FL (US)

(72) Inventors: Jesse A. Wilson, Chatham, IL (US); Kirk T. Evans, Marco Island, FL (US)

(21) Appl. No.: 19/440,065

(22) Filed: Jan. 5, 2026

Related U.S. Application Data
(60) Provisional application No. 63/742,305, filed on Jan. 6, 2025.

(51) Int. Cl. F16M 13/02; H04N 7/18

(52) U.S. Cl. CPC F16M 13/02; H04N 7/186

(57) ABSTRACT

An enclosure assembly for a doorbell can include a housing having an interior compartment, a front bracket assembly positioned at a front side of the enclosure assembly, and a rear bracket assembly positioned at a rear side and coupled to the front bracket assembly. The front bracket assembly can include a front bracket and a cover plate. The cover plate can include a holder and removable inserts configured to selectively provide access to the interior compartment through a central opening defined by the front bracket. The rear bracket assembly can include a rear bracket and at least one support plate slidably positioned within a channel defined by the rear bracket at a rear side of the housing, exterior to the interior compartment. The enclosure assembly can further include a mounting bracket coupled to the rear bracket assembly to secure the housing to a support structure.

### CROSS-REFERENCE TO RELATED APPLICATIONS

This application claims the benefit of U.S. Provisional Patent Application No. 63/742,305, filed Jan. 6, 2025, which is incorporated by reference herein in its entirety.

### BACKGROUND

Video doorbells (e.g., smart doorbells) have increased in popularity. The increase in popularity has also led to an increase in intended damage and/or theft of the video doorbells. What is needed is a secure and customizable metal enclosure that can be used with most, if not all, of the video doorbell products available on the market.

### SUMMARY

According to one aspect of the present disclosure, an enclosure assembly for a doorbell can include a housing. The housing can include an interior compartment. The housing can include a front bracket assembly positioned at a front side of the enclosure assembly. The front bracket assembly can include a front bracket and a cover plate. The cover plate can include a holder and a plurality of removable inserts configured to selectively provide access to the interior compartment through a central opening defined by the front bracket. The housing can include a rear bracket assembly positioned at a rear side of the enclosure assembly and coupled to the front bracket assembly. The rear bracket assembly can include a rear bracket and at least one support plate slidably positioned within a channel defined by the rear bracket at a rear side of the housing, exterior to the interior compartment. The enclosure assembly can include a mounting bracket coupled to the rear bracket assembly to secure the housing to a support structure.

In some examples, the at least one support plate can include a first support plate and a second support plate. The channel can be a first channel that slidably receives at least a portion of the first support plate at an upper side of the rear bracket. The rear bracket assembly can include a second channel that slidably receives at least a portion of the second support plate at a lower side of the rear bracket.

In some examples, the rear bracket can include a first arm and a second arm extending from a body of the rear bracket. The first arm and the second arm can define the first channel and the second channel.

In some examples, the housing can be rotatably coupled to the mounting bracket to allow angular adjustment of the housing relative to the support structure.

In some examples, the housing can be rotatable about a pivot axis defined by at least one fastener coupling the rear bracket to the mounting bracket.

In some examples, the angular adjustment providing a rotation angle can range from approximately 30 degrees in a first rotational direction to approximately 30 degrees in a second rotational direction opposite the first rotational direction.

In some examples, the holder can include a plurality of apertures configured to receive the plurality of removable inserts. The plurality of removable inserts can be configured to selectively engage with the holder to define a window that provides access to the interior compartment.

In some examples, the window can be positioned along one or more of a front side of the front bracket or a lower side of the front bracket.

In some examples, the front bracket assembly can be coupled to the rear bracket assembly via a plurality of security fasteners extending through slots defined by the front bracket and apertures defined by the rear bracket. The slots can extend in an elongate direction parallel to a longitudinal axis of the enclosure assembly.

In some examples, the mounting bracket can include a plurality of break features along one or more of a top wall, a bottom wall, a first lateral wall, or a second lateral wall of the mounting bracket. The break features can be configured to allow selective removal of portions of the mounting bracket to adjust a mounting angle of the mounting bracket relative to the support structure.

In some examples, the front bracket or the rear bracket can include a top wall extending toward the front side of the enclosure assembly. The top wall can extend past a front wall of the front bracket.

According to another aspect of the present disclosure, a bracket assembly for mounting a doorbell can be provided. The doorbell can have features including at least one of a camera, a sensor, or a button. The bracket assembly can include a rear bracket including a body, a first arm extending from the body, and a second arm extending from the body. The first arm and the second arm can define an upper channel and a lower channel between the first and second arms and a rear surface of the body. The bracket assembly can include a first plate positioned within the lower channel. The first plate can include a first aperture configured to receive a first fastener for supporting a first end of the doorbell. The bracket assembly can include a second plate positioned within the upper channel. The second plate can include a second aperture configured to receive a second fastener for supporting a second end of the doorbell. Positions of the first plate and the second plate can be independently adjustable relative to each other.

In some examples, the bracket assembly can further include a mounting bracket that is rotatably coupled to the rear bracket about a pivot axis and configured to secure the bracket assembly to a support structure.

In some examples, the mounting bracket can include a top wall and a bottom wall. The pivot axis can extend between the top wall and the bottom wall.

In some examples, one or more of the first plate or the second plate can be configured to slidably engage with the first arm or the second arm, to adjust a distance between the first aperture and the second aperture.

In some examples, the bracket assembly can further include a front bracket assembly that engages with the rear bracket to at least partially enclose the doorbell.

According to yet another aspect of the present disclosure, an enclosure assembly for a signaling device can be provided. The enclosure assembly can include a first bracket including a front wall defining a central opening, a first side wall, and a second side wall opposite the first side wall. The enclosure assembly can include a second bracket configured to couple to the first bracket via a plurality of retention members. The second bracket can include at least one support plate slidably positioned within a channel defined by the second bracket. The enclosure assembly can include a mounting bracket coupled to the second bracket. The mounting bracket can include a first wall and a second wall. The second bracket can be rotatably coupled to the mounting bracket via fasteners extending through the first wall of the mounting bracket and the second wall of the mounting bracket. The fasteners can define an axis that extends between the first wall and the second wall. The first bracket and the second bracket can be configured to rotate about the axis relative to the mounting bracket. The rotation can provide a range of motion of up to approximately 180 degrees.

In some examples, the range of motion can be up to approximately 60 degrees.

In some examples, the second bracket can include an arm that defines the channel and slidably supports the at least one support plate between the second bracket and the mounting bracket.

In some examples, the first bracket can include a first slot defined by the first side wall and a second slot defined by the second side wall. The first slot and the second slot can extend in a direction perpendicular to the axis. The first slot and the second slot can be configured to receive the plurality of retention members to allow positional adjustment of the first bracket relative to the second bracket in the direction perpendicular to the axis.

### BRIEF DESCRIPTION OF THE DRAWINGS

The accompanying drawings, which are incorporated in and form a part of this specification, illustrate embodiments of the disclosed technology and, together with the description, serve to explain the principles of embodiments of the disclosed technology:

FIG. 1 is a front perspective view of an enclosure assembly including a mounting bracket of the enclosure assembly secured to a mounting surface in a first mounting configuration, according to aspects of the present disclosure.

FIG. 2 is a rear perspective view of the enclosure assembly of FIG. 1, according to aspects of the present disclosure.

FIG. 3 is an exploded view of the enclosure assembly of FIG. 1, according to aspects of the present disclosure.

FIG. 4 is a front perspective view of a front bracket assembly of the enclosure assembly of FIG. 1 including a cover plate, according to aspects of the present disclosure.

FIG. 5 is a rear perspective view of the front bracket assembly of FIG. 4, according to aspects of the present disclosure.

FIG. 6 is a front perspective view of the cover plate of FIG. 4, according to aspects of the present disclosure.

FIG. 7 is a front perspective view of a rear bracket assembly of the enclosure assembly of FIG. 1, according to aspects of the present disclosure.

FIG. 8 is a rear perspective view of the rear bracket assembly of FIG. 7, according to aspects of the present disclosure.

FIG. 9 is a front perspective view of a mounting bracket of the enclosure assembly of FIG. 1, according to aspects of the present disclosure.

FIG. 10 is a rear perspective view of the enclosure assembly of FIG. 1, with the mounting bracket of FIG. 9 in a second mounting configuration, according to aspects of the present disclosure.

FIG. 11 is a front perspective view of the enclosure assembly of FIG. 1, with the mounting bracket of FIG. 9 secured to a mounting surface in a third mounting configuration, according to aspects of the present disclosure.

FIG. 12 is a front perspective view of a second embodiment of an enclosure assembly, according to aspects of the present disclosure.

FIG. 13 is an exploded view of the enclosure assembly of FIG. 12, according to aspects of the present disclosure.

FIG. 14 is a front perspective view of a front bracket of a front bracket assembly of the enclosure assembly of FIG. 12, according to aspects of the present disclosure.

FIG. 15 is a front perspective view of a cover plate of the front bracket assembly of FIG. 12, according to aspects of the present disclosure.

FIG. 16 is a front perspective view of a rear bracket of a rear bracket assembly of the enclosure assembly of FIG. 12, according to aspects of the present disclosure.

FIG. 17 is a rear perspective view of the rear bracket assembly of FIG. 16, according to aspects of the present disclosure.

FIG. 18 is a perspective view of a mounting bracket of the enclosure assembly of FIG. 12, according to aspects of the present disclosure.

FIG. 19 is a side perspective view of the mounting bracket of FIG. 18 and the backplate of FIG. 16, with the mounting bracket secured to a mounting surface in a first mounting configuration, according to aspects of the present disclosure.

FIG. 20A is a top view of the enclosure assembly of FIG. 12 in the first mounting configuration of FIG. 19, according to aspects of the present disclosure.

FIG. 20B is a top view of the enclosure assembly of FIG. 12 in a second mounting configuration, according to aspects of the present disclosure.

FIG. 20C is a top view of the enclosure assembly of FIG. 12 in a third mounting configuration, according to aspects of the present disclosure.

### DETAILED DESCRIPTION

The following discussion is presented to enable a person skilled in the art to make and use embodiments of the disclosed technology. Given the benefit of this disclosure, various modifications to the illustrated embodiments will be readily apparent to those skilled in the art, and the principles herein can be applied to other embodiments and applications without departing from embodiments of the disclosed technology. Thus, embodiments of the disclosed technology are not intended to be limited to embodiments shown but are to be accorded the widest scope consistent with the principles and features disclosed herein.

The following detailed description is to be read with reference to the figures, in which like elements in different figures have like reference numerals. The figures, which are not necessarily to scale, depict selected embodiments and are not intended to limit the scope of embodiments of the disclosed technology. Skilled artisans will recognize the examples provided herein have many useful alternatives and fall within the scope of embodiments of the disclosed technology.

Before any embodiments of the disclosed technology are explained in detail, it is to be understood that the disclosed technology is not limited in its application to the details of construction and the arrangement of components set forth in the following description or illustrated in the following drawings. The disclosed technology is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

Doorbells (e.g., camera doorbells, video doorbells, smart doorbells, etc.) are generally positioned outside residential and commercial buildings to provide security monitoring and visitor communication capabilities. These outdoor installations expose the doorbell devices to environmental conditions such as weather conditions, vandalism, and theft. Different doorbell models can have varying configurations, sizes, and arrangement of features (e.g., lighting, camera, speaker, sensors, microphone, etc.), creating challenges for providing universal protection of the doorbells. Existing enclosure solutions are typically designed for specific doorbell models and lack the flexibility to accommodate different device configurations or allow users to customize which features of the doorbell remain accessible while providing protection.

Examples of the present disclosure can provide improvements in this regard, and various others as further discussed in detail below. In particular, some examples of the present disclosure can provide a customizable enclosure assembly that provides universal compatibility with multiple doorbell configurations while allowing user customization of exposed features of the doorbells. Accordingly, the disclosed enclosure assembly can provide a comprehensive solution that protects doorbell devices from environmental damage or unauthorized access while maintaining functionality and allowing selective exposure of device components.

In particular, an enclosure assembly can be configured as a housing that receives, protects, and mounts a doorbell device. In some examples, the enclosure assembly can include customizable insert subassemblies that allow users to selectively expose specific doorbell features such as cameras, buttons, and sensors while covering other portions. The enclosure assembly can include adjustable mounting mechanisms for accommodating various sizes of doorbell devices with different predetermined mounting patterns, such that a doorbell device can be more flexibly positioned within the enclosure assembly. Further, the enclosure assembly can include a mounting bracket that allows the enclosure assembly to be positioned at adjustable angles relative to a support structure (e.g., a mounting surface), providing desired viewing angles and installation flexibility for different architectural configurations.

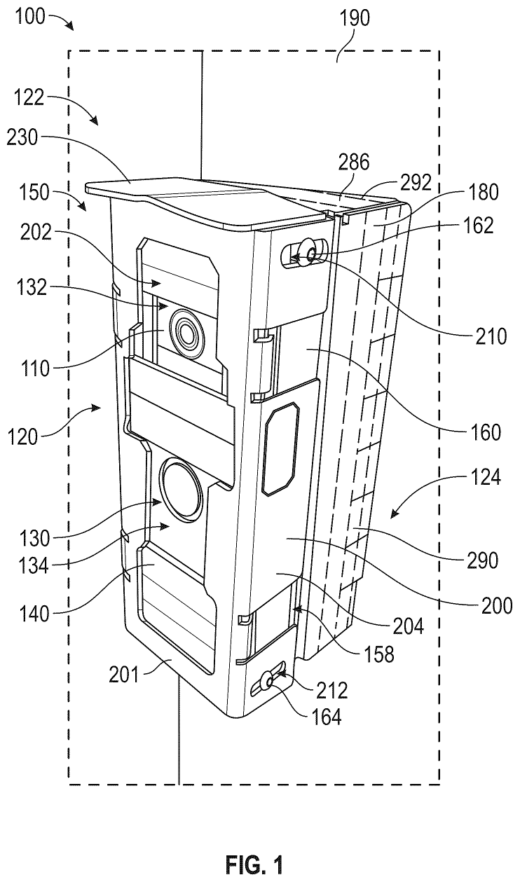

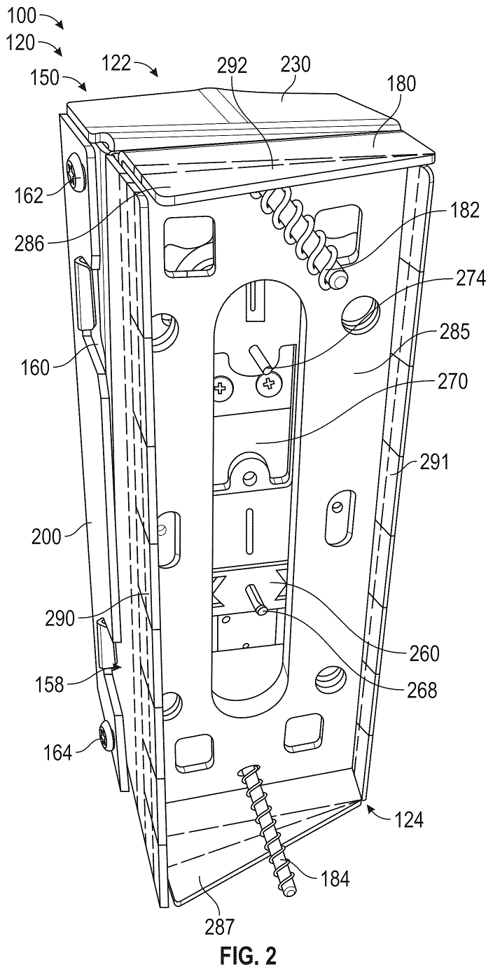

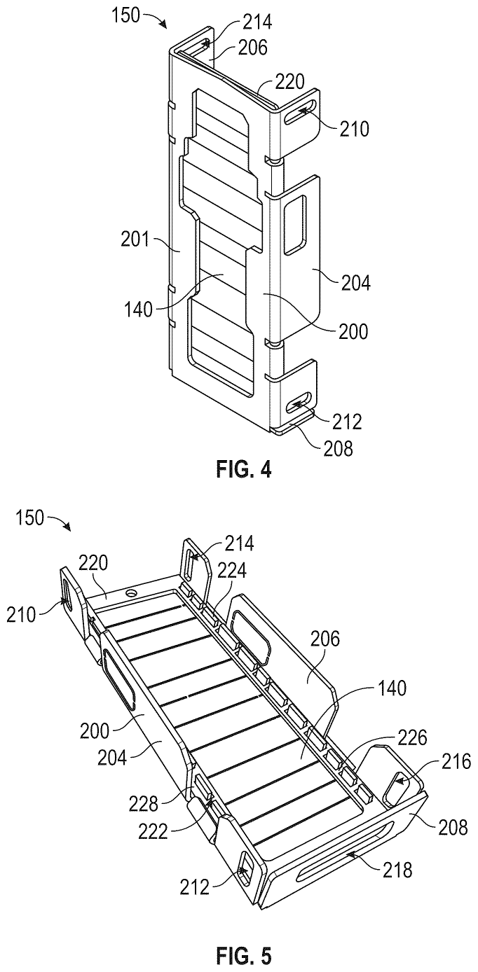

FIGS. 1-11 illustrate an example of an enclosure assembly 100 (e.g., a universal doorbell guard). As shown in FIG. 1, the enclosure assembly 100 can include a housing 120 that receives a device 110 (e.g., signaling device) within an internal compartment of the housing 120. The device 110 can be any of a number of different types of doorbells, signaling devices, monitoring devices, or other types of electronic devices. For example, the device 110 can be configured as a signaling device that uses visual (e.g., lights including light-emitting diodes), audible (e.g., a horn, a bell, or a buzzer), electronic (e.g., strobes or satellite communicators), or any other signal to alert a user. In some examples, a user can provide a signal to the device 110 via a user interface (e.g., a button or a touchscreen). The device 110 can receive a signal from the user (e.g., via a user interface or sensors) and transmits the signal to another user via other devices including a smartphone or a laptop. In some examples, the device 110 can be a doorbell including a video doorbell, a smart doorbell, a wireless doorbell, a battery-powered doorbell, a wired doorbell, a motion-sensing doorbell, a two-way audio doorbell, a night vision doorbell, a Wi-Fi enabled doorbell, a cloud-connected doorbell, or any other electronic doorbell device. In this regard, the enclosure assembly 100 can be configured as a universal protective housing designed to accommodate any of a number of different types of devices with any of a number of different configurations (e.g., shapes, sizes, weight, etc.). For example, the device 110 can be rectangularly-shaped, ovularly-shaped, circularly-shaped, polygonally-shaped, etc. In some examples, the device 110 can include various types of operational features, including a switch, a button, a plurality of cameras, a speaker, a microphone, etc.

In particular, the housing 120 can include various support structures that at least partially enclose the device 110 along one or more sides of the device 110. In some examples, the housing 120 can include a front bracket assembly 150 (e.g., a faceplate subassembly) at a front side 122 of the enclosure assembly 100 and a rear bracket assembly 158 at a rear side 124 of the enclosure assembly 100. The front bracket assembly 150 can provide selective exposure capabilities for the device 110, allowing users to customize which features of the device 110 remain accessible from outside of the housing 120 while providing protection for other portions of the device 110. For example, the front bracket assembly 150 can include a customizable cover plate 202 that extends along the front side 122 and can be configured to selectively expose one or more features of the device 110 (e.g., cameras, buttons, sensors, speaker, microphone, etc.) while covering other portions of the device 110. In some examples, the partial coverage of the device 110 can provide protection for the body of the device 110 while allowing limited access to specific functional components, thereby reducing exposure to potential damage or tampering while maintaining operational capabilities of the device 110.

Referring to FIGS. 1 and 3-6, the front bracket assembly 150 can include a front bracket 200 that supports the cover plate 202. The front bracket 200 can include a front wall 201, a first side wall 204, a second side wall 206 that is opposite the first side wall 204, and a bottom wall 208. The cover plate 202 can be positioned between the first side wall 204, the second side wall 206, and the bottom wall 208. The cover plate 202 can be aligned adjacent to an inner surface of the front wall 201, such that the cover plate 202 is shown through a central opening 130 defined by the front wall 201.

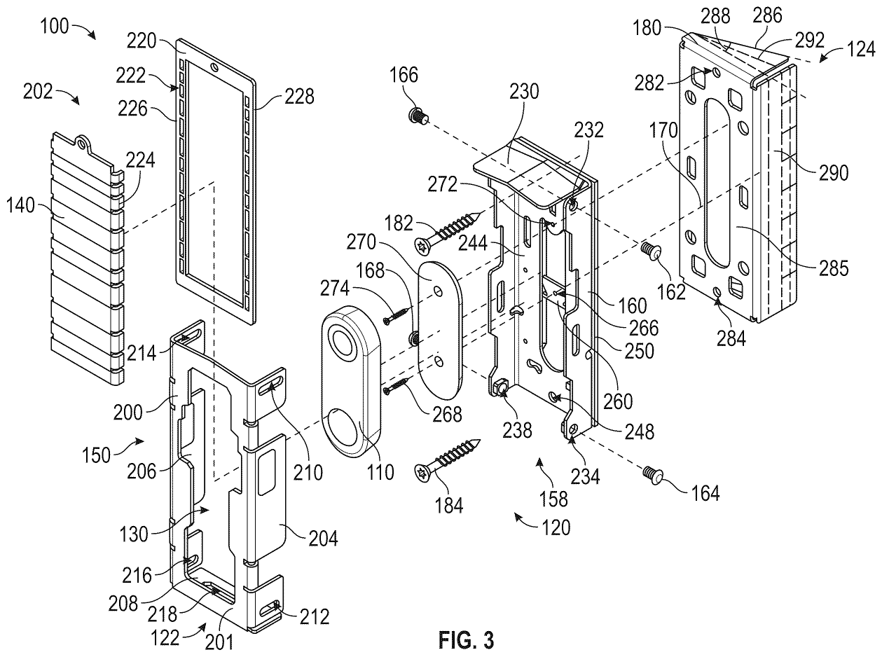

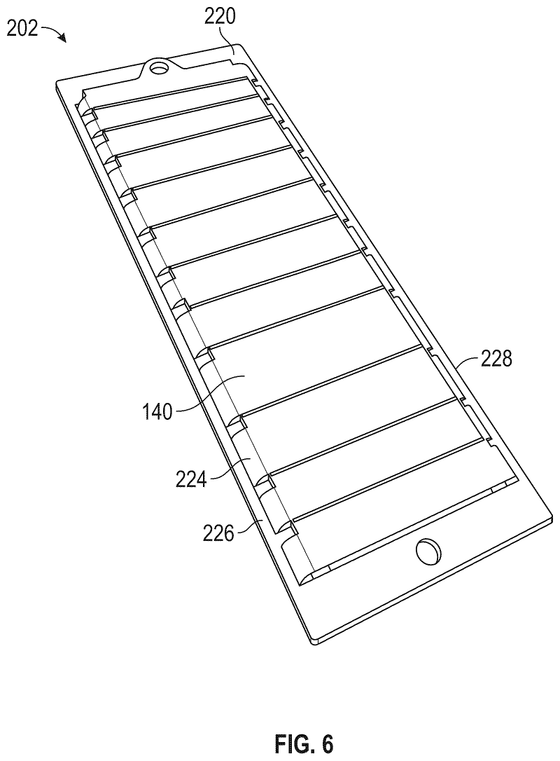

As noted above, the cover plate 202 can selectively provide full coverage or partial coverage of the device 110 when the device 110 is positioned within the housing 120. In particular, the cover plate 202 can include a holder 220 and a plurality of removable inserts 140 (e.g., one or more inserts) that engages with the holder 220. The holder 220 can include a plurality of apertures 222 configured to receive the plurality of removable inserts 140. In some examples, the plurality of apertures 222 can be positioned along a first lateral side 226 of the holder 220 and a second lateral side 228 of the holder 220 that is opposite the first lateral side 226 (e.g., as shown in FIGS. 3 and 6). In some examples, the plurality of apertures 222 can be configured to receive a plurality of arms 224 that are positioned on distal ends of each of the inserts 140. The inserts 140 can (removably) engage with the holder 220 through various attachment mechanisms, including mechanical connections such as snap-fit, interference-fit arrangements, or fasteners, or through chemical bonding such as adhesives.

In some examples, the inserts 140 can be inserted into the corresponding apertures 222 in a direction parallel to the longitudinal axis 170 to cover the central opening 130 at desired heights. The plurality of removable inserts 140 can be configured to selectively engage with the holder 220 to define a window that provides access to the interior compartment. For example, as shown in FIG. 1, the inserts 140 can be spaced from an adjacent insert, such that one or more gaps between the inserts 140 can be configured as a first window 132 for accessing a first feature (e.g., a camera) and a second window 134 for accessing a second feature (e.g., a button). In some examples, the first window 132 or the second window 134 can be positioned along one or more of a front side of the front bracket 200 or a lower side of the front bracket 200. Further, the front bracket 200 can include a second opening 218 along the bottom wall 208, for example, for accessing a third feature (e.g., a second camera, a second button, a sensor, speaker, microphone, etc.). Accordingly, adjusting the configurations of the inserts 140 can provide flexibility in providing access to desired features of the device 110 along one or more portions of the front bracket 200. In some examples, the inserts 140 can protect features of the device 110 intended to not be exposed (e.g., to cover the device 110 except for the camera and the button).

In some examples, the inserts 140 can be provided in various configurations to accommodate different device features and user preferences. For example, the inserts 140 can be provided in a set of multiple inserts that can be supported by the holder 220 as the predetermined set. The inserts 140 can include various heights (e.g., as measured in a vertical direction between a top side of the enclosure assembly 100 and a bottom side of the enclosure assembly 100), to provide further flexibility in providing a desired size of the first window 132 or the second window 134 in the vertical direction. In some examples, the inserts 140 can include various widths (e.g., as measured in a lateral direction between the first lateral side 226 and the second lateral side 228), to provide flexibility in varying the size of the first window 132 or the second window 134 in the lateral direction. While the illustrated example shows twelve inserts 140, other examples of the cover plate 202 can include a fewer number of inserts or a greater number of inserts. In some examples, the number and configuration of inserts 140 can be selected based on the specific features of the device 110 that require exposure and the desired level of protection for other portions of the device 110.

Referring to FIGS. 1-8, the front bracket assembly 150 and the rear bracket assembly 158 can engage with each other via fasteners to at least partially enclose the device 110 along one or more sides of the device 110. In particular, the device 110 can be positioned between the front bracket assembly 150 and the rear bracket assembly 158, and the front bracket assembly 150 can be coupled to the rear bracket assembly 158 for secure attachment. For example, the front bracket 200 can be coupled to the rear bracket 160 via a first retention member 162, a second retention member 164, a third retention member 166, and a fourth retention member 168 (e.g., four security Torx screws). In some examples, coupling the front bracket assembly 150 to the rear bracket assembly 158 via one or more of the first retention member 162, the second retention member 164, the third retention member 166, or the fourth retention member 168 can help to prevent unauthorized access to the interior compartment of the enclosure assembly 100 or the device 110.

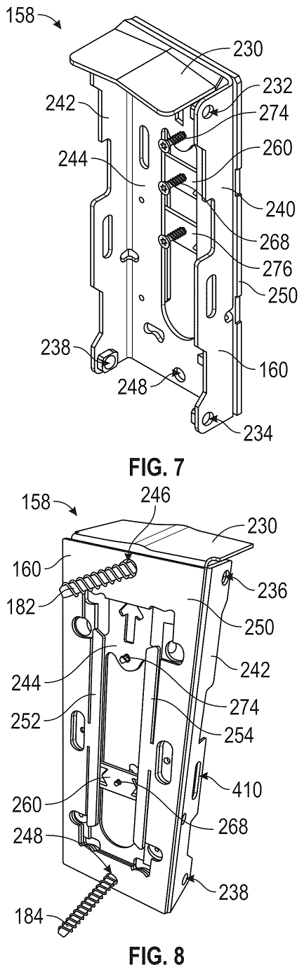

In some examples, the front bracket assembly 150 and the rear bracket assembly 158 can accommodate devices that include varying thicknesses. For example, the front bracket 200 can include a first slot 210 and a second slot 212 that are each defined by the first side wall 204, and a third slot 214 and a fourth slot 216 that are each defined by the second side wall 206. Each of the first slot 210, the second slot 212, the third slot 214, and the fourth slot 216 extend in an elongate direction (e.g., in a direction parallel to the longitudinal axis 170). In some examples, the rear bracket 160 can include a first aperture 232, a second aperture 234, a third aperture 236, and a fourth aperture 238 that are generally circular in shape although other types of shapes are possible (e.g., slots). In some examples, the first apertures 232 and the second aperture 234 can be positioned along a first lateral side 240 of the rear bracket 160. The third aperture 236 and the further aperture 238 can be positioned on a second lateral side 242 of the rear bracket 160 that is opposite the first lateral side 240 (e.g., as shown in FIGS. 7 and 8). Accordingly, in an assembled configuration of the front bracket 200 and the rear bracket 160, each of the retention members 162, 164, 166, 168 can extend through the corresponding slot 210, 212, 214, 216 in the front bracket 200 and the corresponding aperture 232, 234, 236, 238 in the rear bracket 160. In some examples, the position of the front bracket 200 can be adjusted relative to the rear bracket 160 in a direction parallel to the longitudinal axis 170. Correspondingly, the distance between the front bracket 200 and the rear bracket 160 can be increased or decreased to adjust the amount of space within the internal compartment of the housing 120. For example, pulling the front bracket 200 toward the front side 122 can increase the internal space to accommodate a thicker device, while pushing the front bracket 200 toward the rear side 124 can decrease the internal space for a slimmer device.

As mentioned above, the device 110 can be positioned between the front bracket assembly 150 and the rear bracket assembly 158. As shown in FIGS. 7 and 8, the rear bracket assembly 158 can include a rear bracket 160 (e.g., a backplate) with various features for supporting or guarding the device 110 within the housing 120. In the illustrated example, the rear bracket 160 can include a top wall 230, an inner wall 244, and an outer wall 250. The top wall 230 can extend forward from the outer wall 250 in a direction toward the front side 122. In some examples, the top wall 230 can be configured to protect the device 110 from external conditions, for example, as a sun shield and rain guard. In some examples, the top wall 230 can extend toward the front side 122 of the enclosure assembly 100 and past the front wall 201 of the front bracket 200. In some examples, the top wall 230 can be angled, for example, between about 0 degrees and about 15 degrees, or between about 10 degrees and about 30 degrees, or between about 25 degrees and about 50 degrees relative to a horizontal plane (e.g., including an axis perpendicular to the longitudinal axis 170). In some cases, the angled configuration of the top wall 230 can facilitate water runoff and reduce accumulation of debris on the top surface of the enclosure assembly 100. Further, each of the inner wall 244 and the outer wall 250 can include a first mounting hole 246 and a second mounting hole 248 that are each configured to receive a first mounting fastener 182 and a second mounting fastener 184, respectively, to secure the rear bracket 160 to other structures, including a mounting bracket 180 of the enclosure assembly 100.

In some examples, the inner wall 244 and the outer wall 250 can be configured to provide structural support and mounting capabilities for the device 110 within the housing 120. In particular, the outer wall 250 can include a first arm 252 and a second arm 254. In some examples, the first arm 252 and the second arm 254 can be configured to pivotably bend away from the inner wall 244 (e.g., toward the rear side 124) to provide structural support for retaining various structural components for supporting the device 110. For example, bending the first arm 252 and the second arm 254 can create a slight gap or space that help facilitate positioning and retention of mounting interfaces for the device 110 between the inner wall 244 and the outer wall 250, such that the device 110 can be flexibly secured to the rear bracket assembly 158. In some examples, the first arm 252 and the second arm 254 can bend at an angle between about 0 and about 15 degrees, or between about 10 degrees and about 30 degrees, or between about 25 degrees and about 120 degrees (e.g., relative to a vertical plane that includes an axis perpendicular to the longitudinal axis 170).

Continuing, the rear bracket assembly 158 can include a dual-mounting system that includes a fixed mounting point and an adjustable mounting point to accommodate different mounting hole spacings for the device 110. In particular, the rear bracket assembly 158 can include a first support plate 260 (e.g., a sliding screw strap) that is slidably fitted between an inner surface of the outer wall 250 (e.g., including the first arm 252 and the second arm 254) and an outer surface of the inner wall 244. In some examples, the first support plate 260 can be slidably positioned within a channel defined by the rear bracket 160 at a rear side of the housing 120, exterior to the interior compartment. The first support plate 260 can include a first support fastener aperture 266 that is configured to receive a first support fastener 268 for securing the device 110 to the first support plate 260 at a lower end of the device 110. In some examples, a device mount 270 for the device 110 (e.g., provided as part of the device 110 or as a separate component) can be used to secure the device 110 to the first support plate 260 by extending the first support fastener 268 through the device mount 270 and into the first support fastener aperture 266. In some examples, the inner wall 244 can include a second support fastener aperture 272 that is configured to receive a second support fastener 274. In some examples, an upper end of the device 110 can be secured to the rear bracket 160 by extending the second support fastener 274 through the device mount 270 and into the second support fastener aperture 272. Accordingly, the device 110 can be secured to the rear bracket assembly 158 at the inner wall 244 and the first support plate 260.

In some examples, the first support plate 260 can be slidably positioned between the outer wall 250 and the inner wall 244, such that the position of the first support plate 260 can be adjusted in a vertical direction perpendicular to the longitudinal axis 170. As shown in FIG. 7, a second support plate 276 (e.g., substantially similar to the first support plate 260) illustrates a different vertical position of a lower mounting point for the device 110 relative to the first support plate 260. In the illustrated example, the second support plate 276 is located at a lower height than the first support plate 260. When the lower end of the device 110 is mounted to the second support plate 276, the lower mounting point for the device 110 is positioned at a lower vertical height, allowing a longer-sized device to be secured to the rear bracket 160. Accordingly, adjusting the position of the first support plate 260 or the second support plate 276 can allow devices of varying sized mounting patterns (e.g., mounting hole spacings on the device mount 270) to be secured to the rear bracket 160. While the illustrated example shows an upper mounting point as a fixed mounting point and a lower mounting point as an adjustable mounting point, other examples can include an upper mounting point that is configured as an adjustable mounting point and a lower mounting point that is configured as a fixed mounting point.

In some examples, the universal compatibility of the rear bracket assembly 158 can reduce the need to drill new mounting holes when installing different device models (e.g., doorbell models) since the slidable support plates can adjust to match the mounting hole spacing of different devices without requiring modifications to various components of the enclosure assembly 100. Thus, the mounting mechanism of the rear bracket assembly 158 can allow any device models to be securely mounted while maintaining the desired positioning of the device within the enclosure assembly 100.

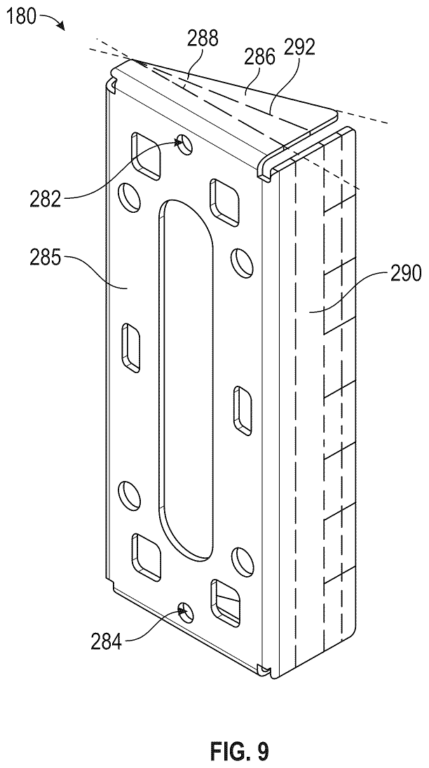

Referring to FIGS. 9-11, the enclosure assembly 100 can include a mounting bracket 180 that provides a mounting interface for securing the housing 120 to a support structure 190. In some examples, the mounting bracket 180 can be coupled to the rear bracket assembly 158 to secure the housing 120 to the support structure 190. In some examples, the mounting bracket 180 can be supported by the rear bracket assembly 158 and provide adjustable positioning capabilities for the enclosure assembly 100 relative to the support structure 190. In some examples, the support structure 190 can include a variety of surfaces and materials, such as house siding, door frames, vinyl, wood, fiber cement, or brick.

In some examples, the mounting bracket 180 can be coupled to the rear bracket 160 via one or more fasteners. In some cases, the mounting bracket 180 can be coupled to the rear bracket 160 via the first mounting fastener 182 at an upper end of the mounting bracket 180 and the second mounting fastener 184 at a lower end of the mounting bracket 180. In particular, the mounting bracket 180 can include a plurality of apertures that are configured to receive the first mounting fastener 182 and the second mounting fastener 184. For example, the mounting bracket 180 can include a first aperture 282 for receiving the first mounting fastener 182 and a second aperture 284 for receiving the second mounting fastener 184. In some examples, the first mounting fastener 182 and the second mounting fastener 184 can be configured as large mounting screws that can be at least 10 times stronger than standard factory-provided screws, to provide a secure attachment to the support structure 190.

The mounting bracket 180 can include adjustable features that allow angled installation relative to the support structure 190, providing flexible viewing angles for the device 110. In particular, the mounting bracket 180 can include a front wall 285, a top wall 286, a bottom wall 287, a first lateral wall 290, and a second lateral wall 291. The top wall 286 and the bottom wall 287 can extend away from the front wall 285 at opposite sides. In some examples, the top wall 286 and the bottom wall 287 can be triangular-shaped and include an edge that extends between the second lateral wall 291 and the first lateral wall 290. The edges of the top wall 286 and the bottom wall 287 can be sloped at an angle 288 relative to the front wall 285 toward the first lateral wall 290. For example, the angle 288 can be between about 0 degrees and about 10 degrees, or between about 5 degrees and about 30 degrees, or between about 25 degrees and about 50 degrees, or between about 45 degrees and about 90 degrees. In some examples, the triangular-shaped top wall 286 and the bottom wall 287 can allow the mounting bracket 180 to be coupled to the support structure 190 at various angles, accommodating different installation configurations such as flat surfaces, siding, or angled mounting positions.

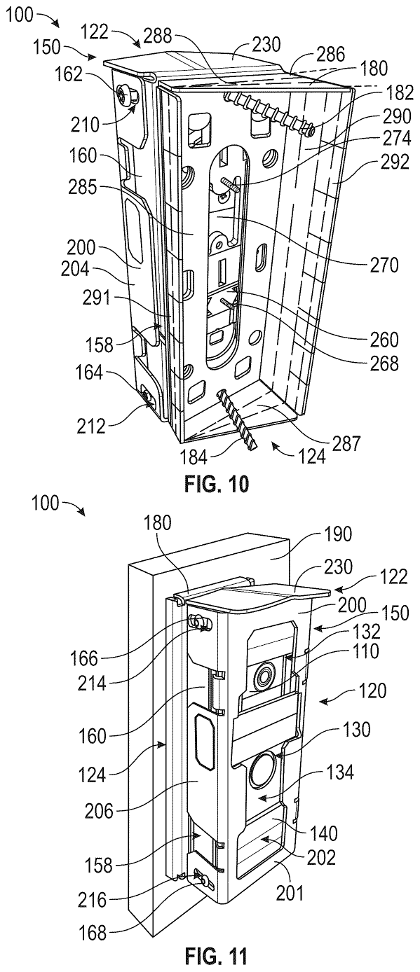

In some examples, the mounting angle of the mounting bracket 180 can be adjusted according to user preferences or requirements of the applications. In particular, the mounting bracket 180 can include a plurality of break features 292 (e.g., a plurality of break lines) along one or more of the top wall 286, the bottom wall 287, the first lateral wall 290, or the second lateral wall 291. The break features 292 can be configured to allow selective removal of portions of the mounting bracket 180 to adjust a mounting angle of the mounting bracket 180 relative to the support structure 190, for example, by breaking or tearing of portions of the top wall 286, the bottom wall 287, the first lateral wall 290, or the second lateral wall 291. By selectively removing materials along the break features 292, the mounting angle of the mounting bracket 180 relative to the support structure 190 can be customized. For example, the mounting bracket 180 can be mounted at an angle ranging from about 0 to about 10 degrees, or from about 5 degrees to about 20 degrees, or from about 15 degrees to about 45 degrees relative to the support structure 190. This angular adjustment capability allows the enclosure assembly 100 to be positioned in a “look left” configuration (angled to the left; e.g., as shown in FIG. 10), a “look right” configuration (angled to the right; e.g., as shown in FIG. 1), or a “straight” configuration with no angle, as illustrated in FIG. 11. Accordingly, the adjustable mounting configuration can provide universal compatibility with various architectural configurations and allows optimal positioning of the device 110 for desired viewing angles.

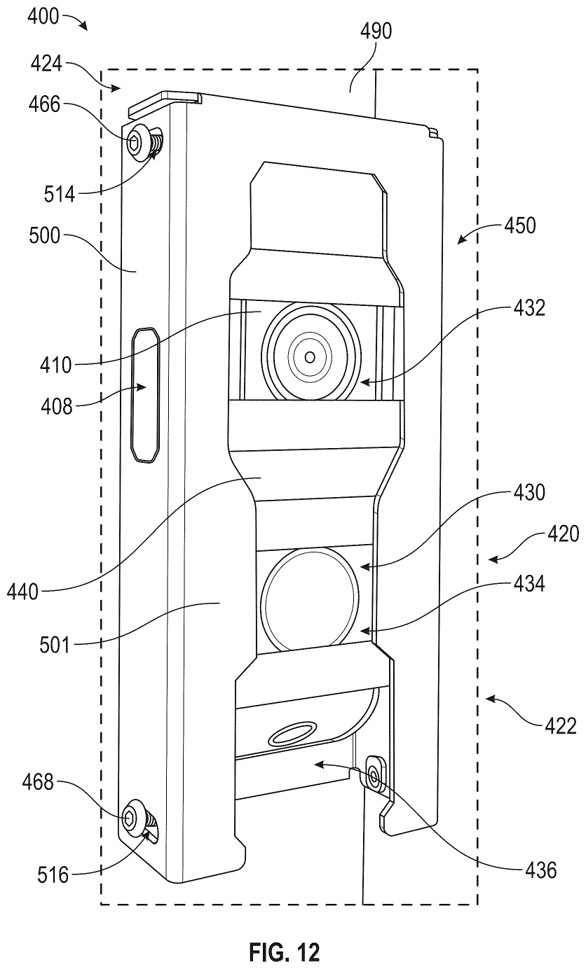

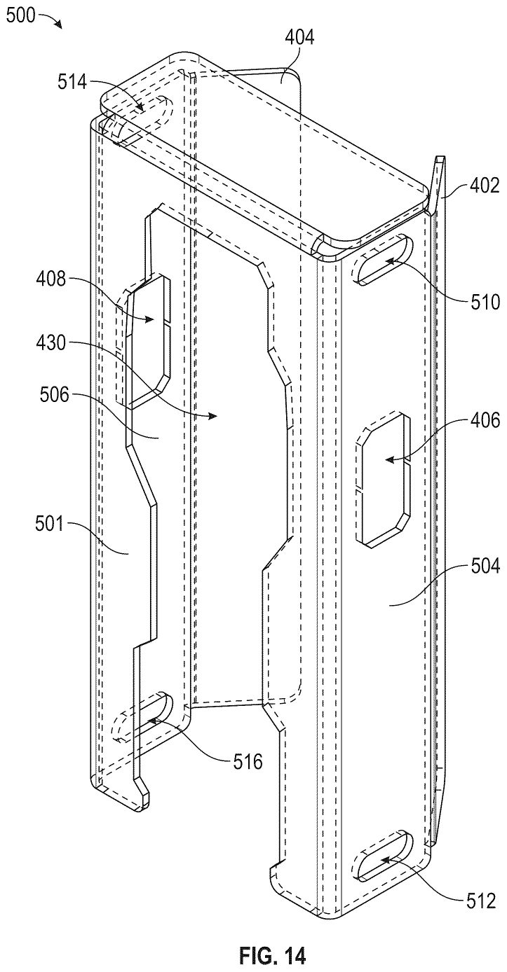

FIGS. 12-20C illustrate an example enclosure assembly 400, which is one particular example of the enclosure assembly 100 of FIG. 1. To that end, features of the enclosure assembly 400 described below include similar names and numbers that are generally similar to those used in FIGS. 1-11, and discussion of above applies to similar names and numbers unless otherwise noted or required. Further, the discussion of below can apply to similar names and numbers of the enclosure assembly 100 of FIGS. 1-11 above. For example, the enclosure assembly 400 includes a front bracket 500, just as the enclosure assembly 100 has the front bracket 200.

Similar to those used in FIGS. 1-11, the enclosure assembly 400 can be configured to receive a device 410. The device 410 can be any number of different types of devices 410, including a video doorbell or a smart doorbell. The enclosure assembly 400 can further include a housing 420 that at least partially encloses the device 410 and defines a central opening 430 for selectively providing access to the device 410, for example, through a first window 432, a second window 434, and a third window 436. The first window 432, the second window 434, and the third window 436 can be configured to expose various features of the device 410. For example, as shown in FIG. 12, the third window 436 can be configured to expose a feature along a bottom side of the device 410. Further, the housing 420 can include a front bracket subassembly 450 and a rear bracket assembly 458 that is coupled to the front bracket subassembly 450 via fasteners. In some examples, the front bracket subassembly 450 is coupled to the rear bracket assembly 458 via a first retention member 462, a second retention member 464, a third retention member 466, and a fourth retention member 468.

The front bracket subassembly 450 can include a front bracket 500 and a cover plate 502. As shown in FIGS. 12-14, the front bracket 500 can include a front wall 501 defining a central opening 430, a first side wall 504, and a second side wall 506 opposite the first side wall 504. In some examples, the front bracket 500 can include a first panel 402 and a second panel 404 that extend away from a body portion of the front bracket 500. In some examples, the first panel 402 and the second panel 404 can bend toward a central axis of the front bracket 500, for example, in a direction perpendicular to a longitudinal axis 470 that extends between a front side 422 of the enclosure assembly 400 and a rear side 424 of the enclosure assembly 400. For example, the bending angle can be from about 0 degrees to about 20 degrees, or from about 15 degrees to about 50 degrees, or from about 45 degrees to about 90 degrees. In some examples, the front bracket 500 can include a first side aperture 406 on the first side wall 504 and a second side aperture 408 on the second side wall 506 for providing access to various features of the device 410, including one or more sensors. In some examples, the front bracket 500 can include a first slot 510, a second slot 512, a third slot 514, and a fourth slot 516. The first slot 510 and the second slot 512 may be positioned on the first side wall 504. The third slot 514 and the fourth slot 516 may be positioned on the second side wall 506.

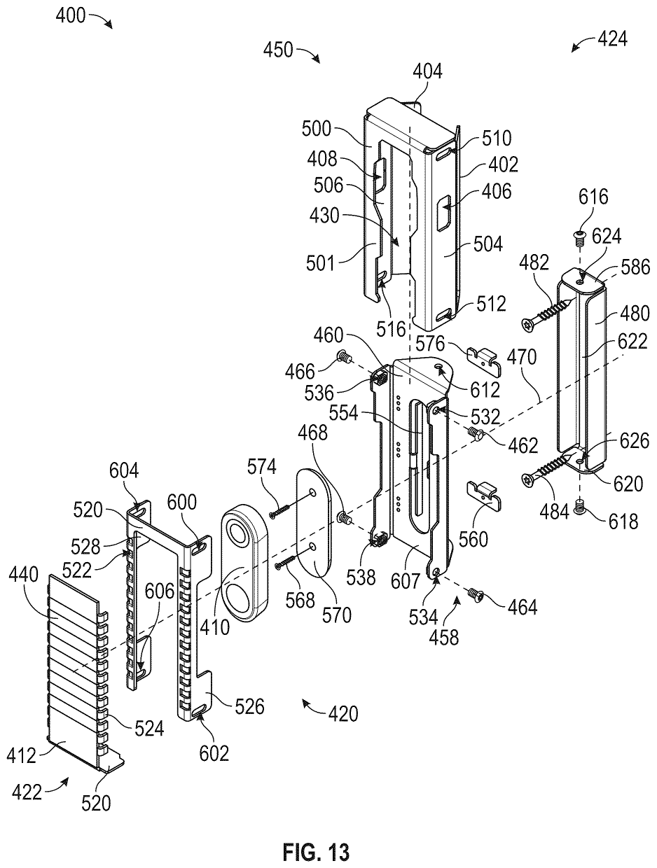

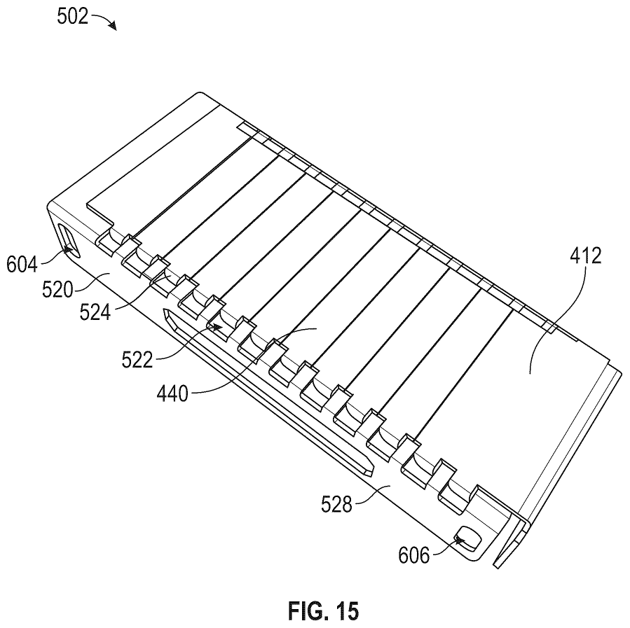

The front bracket assembly 450 can be configured to receive a cover plate 502. As shown in FIGS. 13 and 15, the cover plate 502 can include a holder 520 and a plurality of inserts 440 that are secured to the holder 520. Each of the plurality of inserts 440 can include a pair of arms 524 at distal ends, and each of the arms 524 can be received into a corresponding aperture 522 of the holder 520 to secure the insert 440 to the holder 520. In some examples, the holder 520 can include a first side wall 526 and a second side wall 528 opposite the first side wall 526. The holder 520 can include a first slot 600 and a second slot 602 on the first side wall 526, and a third slot 604 and a fourth slot 606 on the second side wall 528. In some examples, the first slot 600 and the second slot 602 can extend in a direction perpendicular to the pivot axis 634. The slots 600, 602, 604, 606 can be positioned to align with slots 510, 512, 514, 516 of the front bracket 500 in an assembled configuration of the front bracket assembly 450. In the illustrated example, the slots 600, 602, 604, 606 can be configured to receive corresponding retention members 462, 464, 466, 468 (e.g., in a direction perpendicular to the longitudinal axis 470) to secure holder 520 to the front bracket 500. In some examples, the first slot 600 and the second slot 602 can be configured to receive the plurality of retention members to allow positional adjustment of the front bracket 500 relative to the rear bracket 460 in a direction perpendicular to the pivot axis 634.

As similarly discussed above relative to FIGS. 1-11, the inserts 440 can be provided in various configurations with different heights and widths, similar to the inserts 140 discussed above, to provide flexibility in adjusting the size and position of the windows 432, 434, 436 for accommodating different device features and user preferences. For example, the inserts 440 can include a lower insert piece 412 along a bottom side of the cover plate 502. In some examples, the lower insert piece 412 can engage with the holder 520 to selectively cover or provide access to the bottom portion of the device 410.

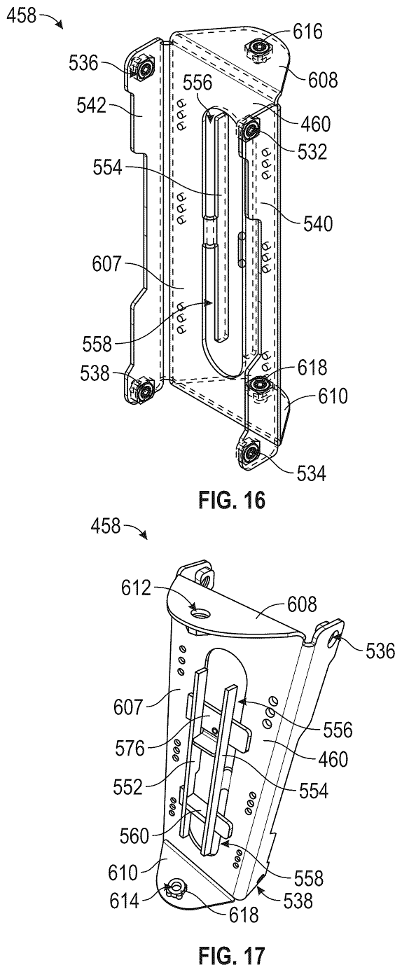

Referring to FIGS. 16 and 17, the rear bracket 460 can include a body 607, a top wall 608, a bottom wall 610, a first side wall 540, and a second side wall 542. The top wall 608 and the bottom wall 610 can extend from the body 607 in a different direction than the first side wall 540 and the second side wall 542. In some examples, the rear bracket 460 can be formed as a single, unitary piece, eliminating the need for spot welding or multi-piece construction. This one-piece construction can provide improved structural integrity and simplified manufacturing compared to multi-piece rear bracket designs. In some examples, the top wall 608 can include a first aperture 612, and the bottom wall 610 can include a second aperture 614. The first aperture 612 and the second aperture 614 can be configured to receive a first fastener 616 and a second fastener 618, respectively, to secure the rear bracket 460 to a mounting bracket 480. In some examples, the rear bracket 460 can be configured to couple to the front bracket 500 via the plurality of retention members 462, 464, 466, 468. Similar to enclosure assembly 100, the rear bracket 460 can include a first aperture 532, a second aperture 534, a third aperture 536, and a fourth aperture 538. The first aperture 532 and the second aperture 534 can be positioned on the first side wall 540. The third aperture 536 and the fourth aperture 538 can be positioned on the second side wall 542. Accordingly, the apertures 532, 534, 536, 538 can be aligned with the corresponding one of the slots 510, 512, 514, 516 of the front bracket 500. In some cases, the apertures 532, 534, 536, 538 can be positioned to align with slots 600, 602, 604, and 606 of the holder 520 to further provide secure attachment of the cover plate 502 between the front bracket 500 and the rear bracket 460.

The rear bracket assembly 458 can include a dual adjustable mounting system that accommodates devices of varying sizes and mounting hole configurations through the use of two independently slidable support plates. In particular, the rear bracket 460 can include a first arm 552 and second arm 554 that extend from the body 607. In some examples, the first arm 552 and the second arm 554 can be bent away from the body 607 at an angle (e.g., 90 degrees) and provide an upper channel 556 and a lower channel 558 between the first and second arms 552, 554 and a rear surface of the body 607. As shown in FIG. 17, the lower channel 558 can receive a first support plate 560 at a lower side of the rear bracket 460, and the upper channel 556 can receive a second support plate 576 at an upper side of the rear bracket 460.

In some examples, the first support plate 560 and the second support plate 576 can be slidably positioned within the lower channel 558 and the upper channel 556, respectively. In one example, the first arm 552 and the second arm 554 can retain the first support plate 560 in the lower channel 558 via an interference fit between the first arm 552 and the body 607 and further between the second arm 554 and the body 607 The first arm 552 and the second arm 554 can retain the second support plate 576 in the upper channel 556 via an interference fit between the first arm 552 and the body 607 and further between the second arm 554 and the body 607.

As discussed above, the positions of the first support plate 560 and the second support plate 576 can be independently adjusted to accommodate different device configurations, including different mounting patterns of the device mount 570. In particular, a device mount 570 for the device 410 can be coupled to the first support plate 560 through a first fastener 568 (e.g., shown in FIG. 13) and to the second support plate 576 through a second fastener 574 (e.g., shown in FIG. 13).

To install the device 410, the user can slide the first support plate 560 and the second support plate 576 into desired positions within the lower channel 558 and the upper channel 556, respectively. When the first fastener 568 is loosened, the first support plate 560 can slide freely within the lower channel 558, and when the second fastener 574 is loosened, the second support plate 576 can slide freely within the upper channel 556, allowing the user to position the device 410 at the desired location. When tightened through the device mount 570, the first fastener 568 can secure the device 410 to the first support plate 560 and lock the first support plate 560 in place within the lower channel 558, while the second fastener 574 can secure the device 410 to the second support plate 576 and lock the second support plate 576 within the upper channel 556. Accordingly, the relative adjustability of the first support plate 560 and the second support plate 576 can allow the rear bracket assembly 458 to support devices with various dimensions and predetermined mounting requirements, providing universal compatibility with a wide range of doorbell models without requiring modifications to components of the enclosure assembly 400.

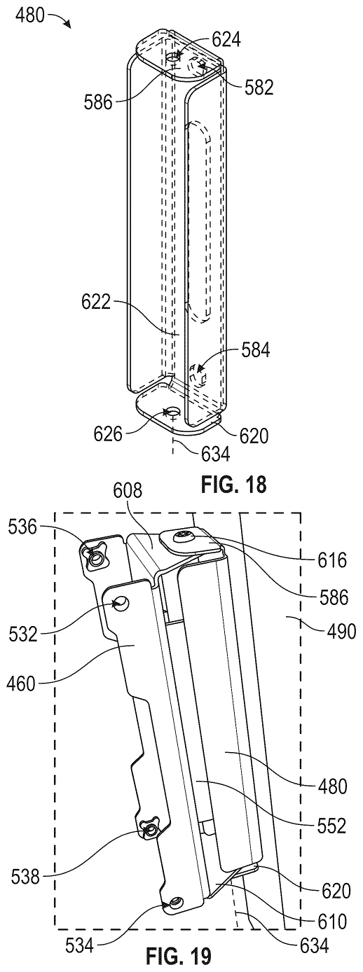

As mentioned above, the rear bracket 460 can be coupled to the mounting bracket 480. Referring to FIGS. 18-20C, the mounting bracket 480 can include a top wall 586, a bottom wall 620, and an outer wall 622. The top wall 586 and the bottom wall 620 can extend from the outer wall 622 in a direction toward the rear side 424 of the enclosure assembly 400. In some examples, the outer wall 622 can be configured as a mounting interface between the mounting bracket 480 and a support structure 490. The top wall 586 can include a first aperture 624 that can align with the first aperture 612 of the rear bracket 460. The bottom wall 620 can include a second aperture 626 that can align with the second aperture 614 of the rear bracket 460. The first aperture 624 and second aperture 626 of the mounting bracket 480 can be configured to receive the first fastener 616 and the second fastener 618, respectively. In some examples, the first fastener 616 and the second fastener 618 of the mounting bracket 480 are the same first fastener 616 and second fastener 618 received in the rear bracket 460. Accordingly, the first fastener 616 and second fastener 618 can couple the mounting bracket 480 to the housing 420.

In some examples, the housing 420 can be rotatably coupled to the mounting bracket 480 to allow angular adjustment of the housing 420 relative to the support structure 490. The housing 420 can rotate relative to the mounting bracket 480 about a pivot axis 634 to provide angular adjustment capabilities for positioning the device 410 at desired viewing angles. In some examples, the first fastener 616 and the second fastener 618 can serve as pivot points that allow rotational adjustment of the housing 420 relative to the mounting bracket 480. In particular, the housing 420 can be rotatable about the pivot axis 634 defined by at least one fastener coupling the rear bracket 460 to the mounting bracket 480. The pivot axis 634 can extend through an axis of the first fastener 616 and the second fastener 618, or through the first aperture 624 and the second aperture 626 of the mounting bracket 480, or through the first aperture 612 and the second aperture 614 of the rear bracket 460. In some examples, the pivot axis 634 can extend between the top wall 586 and the bottom wall 620 of the mounting bracket 480.

Referring to FIG. 18, the outer wall 622 of the mounting bracket 480 can define a first mounting aperture 582 and a second mounting aperture 584. Similar to the mounting bracket 180, the first mounting aperture 582 and the second mounting aperture 584 can be configured to receive a fastener for securing the mounting bracket 480 to the support structure 490. In the illustrated example, the first mounting aperture 582 is configured to receive a first mounting fastener 482, and the second aperture 584 can be configured to receive a second mounting fastener 484. The first mounting fastener 482 and the second mounting fastener 484 can couple the mounting bracket 480 to the support surface 490. In some examples, the first mounting fastener 482 and the second mounting fastener 484 can be configured as large mounting screws, such as Tapcon screws, that provide enhanced structural attachment strength compared to standard factory-provided screws.

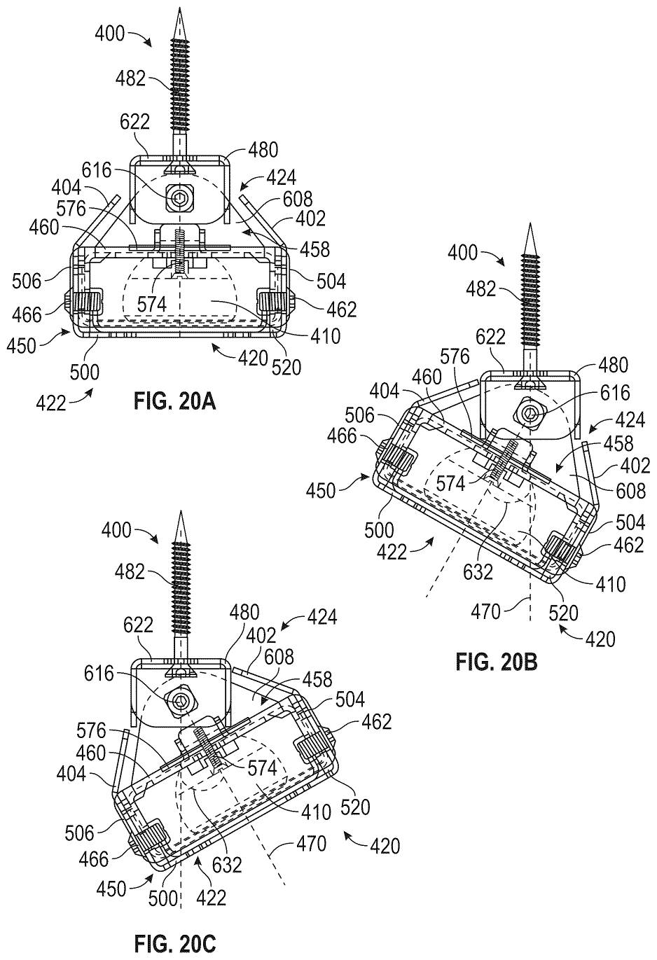

In some examples, the housing 420 can be rotatably coupled with the mounting bracket 480. The housing 420 can rotate about the first fastener 616 and the second fastener 618, which serve as pivot axes for the rotational adjustment. The housing 420 can be rotated an angle 632 relative to the longitudinal axis 470. In some examples, the angular adjustment can provide a rotation angle that ranges from approximately 30 degrees in a first rotational direction to approximately 30 degrees in a second rotational direction opposite the first rotational direction, providing a total range of motion of up to approximately 60 degrees. In some examples, the range of motion can be up to approximately 180 degrees, 270 degrees, or 360 degrees. As shown in FIG. 20A and FIG. 21, the housing 420 can be positioned in a neutral position (e.g., a “straight” configuration), where the housing 420 is oriented substantially perpendicular to the support surface 490 without angular offset. As shown in FIG. 20B, the housing 420 can be positioned as rotated to the right (e.g., a “look right” position), where the front side 422 of the housing 420 is angled toward the right relative to the support surface 490. As shown in FIG. 20C, the housing 420 can be positioned as rotated to the left (e.g., a “look left” position), where the front side 422 of the housing 420 is angled toward the left relative to the support surface 490. This rotational adjustability allows the enclosure assembly 400 to be configured for optimal viewing angles based on the specific installation location and user preferences, accommodating various architectural configurations without requiring repositioning of the mounting bracket 480 on the support surface 490.

In some examples, a method of using the enclosure assembly 400 to secure a doorbell to a support structure 490 can include positioning the mounting bracket 480 against the support structure 490 and securing the mounting bracket 480 to the support structure 490 via the first mounting fastener 482 and the second mounting fastener 484. The rear bracket 460 can be coupled to the mounting bracket 480 by aligning the first aperture 612 of the rear bracket 460 with the first aperture 624 of the mounting bracket 480 and aligning the second aperture 614 of the rear bracket 460 with the second aperture 626 of the mounting bracket 480, and inserting the first fastener 616 and the second fastener 618 through the aligned apertures. In some cases, the positions of the first support plate 560 and the second support plate 576 can be adjusted within the lower channel 558 and the upper channel 556, respectively, to accommodate the mounting hole spacing of the device 410. For example, the device mount 570 can be secured to the first support plate 560 and the second support plate 576 via the first fastener 568 and the second fastener 574, respectively, to mount the device 410 to the rear bracket assembly 458. In some examples, the cover plate 502 can be provided within the front bracket 500, and the inserts 440 can selectively expose desired features of the device 410 through the windows 432, 434, 436. The front bracket assembly 450 can be coupled to the rear bracket assembly 458 via the retention members 462, 464, 466, 468 to enclose the device 410 within the housing 420. In some examples, the housing 420 can be rotated about the pivot axis 634 relative to the mounting bracket 480 to position the device 410 at a desired viewing angle prior to fully tightening the first fastener 616 and the second fastener 618. In some examples, the steps of the method above can be performed in any suitable order, and certain steps may be performed simultaneously or in a different sequence than described above.

The enclosure assemblies 100, 400 can include components manufactured via laser cutting. In some examples, the enclosure assemblies 100, 400 can include spot weld locations. The enclosure assemblies 100, 400 can define apertures configured for powder coating. In some examples, the enclosure assemblies 100, 400 can be manufactured from steel. The Universal Doorbell Guard can be made of 14 gage galvanized steel or other structurally comparable materials. The enclosure assemblies 100, 400 can include a powder coat. A durable powder coating can be included to protect various components of the enclosure assemblies 100, 400 from external conditions.

In some implementations, devices or systems disclosed herein can be utilized, manufactured, or installed using methods embodying aspects of the disclosed technology. Correspondingly, any description herein of particular features, capabilities, or intended purposes of a device or system is generally intended to include disclosure of a method of using such devices for the intended purposes, a method of otherwise implementing such capabilities, a method of manufacturing relevant components of such a device or system (or the device or system as a whole), and a method of installing disclosed (or otherwise known) components to support such purposes or capabilities. Similarly, unless otherwise indicated or limited, discussion herein of any method of manufacturing or using for a particular device or system, including installing the device or system, is intended to inherently include disclosure, as embodiments of the disclosed technology, of the utilized features and implemented capabilities of such device or system.

Also as used herein, unless otherwise limited or defined, “or” indicates a non-exclusive list of components or operations that can be present in any variety of combinations, rather than an exclusive list of components that can be present only as alternatives to each other. For example, a list of “A, B, or C” indicates options of: A; B; C; A and B; A and C; B and C; and A, B, and C. Correspondingly, the term “or” as used herein is intended to indicate exclusive alternatives only when preceded by terms of exclusivity, such as “either,” “one of,” “only one of,” or “exactly one of.” For example, a list of “one of A, B, or C” indicates options of: A, but not B and C; B, but not A and C; and C, but not A and B. A list preceded by “one or more” (and variations thereon) and including “or” to separate listed elements indicates options of one or more of any or all of the listed elements. For example, the phrases “one or more of A, B, or C” and “at least one of A, B, or C” indicate options of: one or more A; one or more B; one or more C; one or more A and one or more B; one or more B and one or more C; one or more A and one or more C; and one or more of A, one or more of B, and one or more of C. Similarly, a list preceded by “a plurality of” (and variations thereon) and including “or” to separate listed elements indicates options of multiple instances of any or all of the listed elements. For example, the phrases “a plurality of A, B, or C” and “two or more of A, B, or C” indicate options of: A and B; B and C; A and C; and A, B, and C.

As used herein, unless otherwise defined or limited, directional terms are used for convenience of reference for discussion of particular figures or examples. For example, references to downward (or other) directions or top (or other) positions may be used to discuss aspects of a particular example or figure, but do not necessarily require similar orientation or geometry in all installations or configurations.

As used herein, unless otherwise defined or limited, two components that are described herein as “aligned”, relative to a reference direction, are each at least partly located along a common reference line in the reference direction. Thus, for example, components that are described as “vertically aligned” are aligned along a common vertical line.

As used herein, unless otherwise defined or limited, the term “lateral” refers to a direction, at least a component of which does not extend in parallel with a reference direction. In some cases, a lateral direction can be a radial (i.e., perpendicularly outward) direction relative to an axis that extends in a reference direction (e.g., a center or centroid axis of an enclosure assembly).

Additionally, unless otherwise specified or limited, the terms “about” and “approximately,” as used herein with respect to a reference value, refer to variations from the reference value of plus or minus 15 percent or less, inclusive of the endpoints of the range. Similarly, the term “substantially equal” (and the like) as used herein with respect to a reference value refers to variations from the reference value of less than plus or minus 30 percent, inclusive. Where specified, “substantially” can indicate in particular a variation in one numerical direction relative to a reference value. For example, “substantially less” than a reference value (and the like) indicates a value that is reduced from the reference value by 30 percent or more, and “substantially more” than a reference value (and the like) indicates a value that is increased from the reference value by 30 percent or more.

Also as used herein, unless otherwise specified or limited, “substantially parallel” indicates a direction that is within ±12 degrees of a reference direction (e.g., within ±6 degrees or ±3 degrees), inclusive. Similarly, unless otherwise specified or limited, “substantially perpendicular” similarly indicates a direction that is within ±12 degrees of perpendicular to a reference direction (e.g., within ±6 degrees or ±3 degrees), inclusive. Correspondingly, “substantially vertical” indicates a direction that is substantially parallel to the vertical direction, as defined relative to the reference system (e.g., a local direction of gravity, by default), with a similarly derived meaning for “substantially horizontal” (relative to the horizontal direction). Discussion of directions “transverse” to a reference direction indicate directions that are not substantially parallel to the reference direction. Correspondingly, some transverse directions may be perpendicular or substantially perpendicular to the relevant reference direction.

Unless otherwise specifically indicated, ordinal numbers are used herein for convenience of reference, based generally on the order in which particular components are presented in the relevant part of the disclosure. In this regard, for example, designations such as “first,” “second,” etc., generally indicate only the order in which a thus-labeled component is introduced for discussion and generally do not indicate or require a particular spatial, functional, temporal, or structural primacy or order. Relatedly, similar or identical components may be referred to with different ordinal numbers in different contexts.

The previous description of the disclosed embodiments is provided to enable any person skilled in the art to make or use the disclosed technology. Given the benefit of this disclosure, various modifications to these embodiments will be readily apparent to those skilled in the art, and the principles defined herein may be applied to other embodiments without departing from the spirit or scope of the disclosed technology. Thus, the disclosed technology is not intended to be limited to the embodiments shown herein but is to be accorded the widest scope consistent with the principles and novel features disclosed herein.

We claim

1. An enclosure assembly for a doorbell, comprising:
a housing, including:
an interior compartment;
a front bracket assembly positioned at a front side of the enclosure assembly, the front bracket assembly including a front bracket and a cover plate, the cover plate including a holder and a plurality of removable inserts configured to selectively provide access to the interior compartment through a central opening defined by the front bracket; and
a rear bracket assembly positioned at a rear side of the enclosure assembly and coupled to the front bracket assembly, the rear bracket assembly including a rear bracket and at least one support plate slidably positioned within a channel defined by the rear bracket at a rear side of the housing, exterior to the interior compartment; and
a mounting bracket coupled to the rear bracket assembly to secure the housing to a support structure.

2. The enclosure assembly of claim 1, wherein the at least one support plate includes a first support plate and a second support plate, and the channel is a first channel that slidably receives at least a portion of the first support plate at an upper side of the rear bracket, and
wherein the rear bracket assembly includes a second channel that slidably receives at least a portion of the second support plate at a lower side of the rear bracket.

3. The enclosure assembly of claim 2, wherein the rear bracket includes a first arm and a second arm extending from a body of the rear bracket, the first arm and the second arm defining the first channel and the second channel.

4. The enclosure assembly of claim 1, wherein the housing is rotatably coupled to the mounting bracket to allow angular adjustment of the housing relative to the support structure.

5. The enclosure assembly of claim 4, wherein the housing is rotatable about a pivot axis defined by at least one fastener coupling the rear bracket to the mounting bracket.

6. The enclosure assembly of claim 4, wherein the angular adjustment providing a rotation angle ranges from approximately 30 degrees in a first rotational direction to approximately 30 degrees in a second rotational direction opposite the first rotational direction.

7. The enclosure assembly of claim 1, wherein the holder includes a plurality of apertures configured to receive the plurality of removable inserts, the plurality of removable inserts configured to selectively engage with the holder to define a window that provides access to the interior compartment.

8. The enclosure assembly of claim 7, wherein the window is positioned along one or more of a front side of the front bracket or a lower side of the front bracket.

9. The enclosure assembly of claim 1, wherein the front bracket assembly is coupled to the rear bracket assembly via a plurality of security fasteners extending through slots defined by the front bracket and apertures defined by the rear bracket, the slots extending in an elongate direction parallel to a longitudinal axis of the enclosure assembly.

10. The enclosure assembly of claim 1, wherein the mounting bracket includes a plurality of break features along one or more of a top wall, a bottom wall, a first lateral wall, or a second lateral wall of the mounting bracket, the break features configured to allow selective removal of portions of the mounting bracket to adjust a mounting angle of the mounting bracket relative to the support structure.

11. The enclosure assembly of claim 1, wherein the front bracket or the rear bracket includes a top wall extending toward the front side of the enclosure assembly, the top wall extending past a front wall of the front bracket.

12. A bracket assembly for mounting a doorbell, the doorbell having features including at least one of a camera, a sensor, or a button, the bracket assembly comprising:
a rear bracket including a body, a first arm extending from the body, and a second arm extending from the body, the first arm and the second arm defining an upper channel and a lower channel between the first and second arms and a rear surface of the body;
a first plate positioned within the lower channel, the first plate including a first aperture configured to receive a first fastener for supporting a first end of the doorbell; and
a second plate positioned within the upper channel, the second plate including a second aperture configured to receive a second fastener for supporting a second end of the doorbell,
wherein positions of the first plate and the second plate are independently adjustable relative to each other.

13. The bracket assembly of claim 12, further comprising a mounting bracket that is rotatably coupled to the rear bracket about a pivot axis and configured to secure the bracket assembly to a support structure.

14. The bracket assembly of claim 13, wherein the mounting bracket includes a top wall and a bottom wall, the pivot axis extending between the top wall and the bottom wall.

15. The bracket assembly of claim 12, wherein one or more of the first plate or the second plate are configured to slidably engage with the first arm or the second arm, to adjust a distance between the first aperture and the second aperture.

16. The bracket assembly of claim 12, further comprising:
a front bracket assembly that engages with the rear bracket to at least partially enclose the doorbell.

17. An enclosure assembly for a signaling device, comprising:
a first bracket including a front wall defining a central opening, a first side wall, and a second side wall opposite the first side wall;
a second bracket configured to couple to the first bracket via a plurality of retention members, the second bracket including at least one support plate slidably positioned within a channel defined by the second bracket; and
a mounting bracket coupled to the second bracket, the mounting bracket including a first wall and a second wall,
wherein the second bracket is rotatably coupled to the mounting bracket via fasteners extending through the first wall of the mounting bracket and the second wall of the mounting bracket, the fasteners defining an axis that extends between the first wall and the second wall, the first bracket and the second bracket configured to rotate about the axis relative to the mounting bracket, the rotation providing a range of motion of up to approximately 180 degrees.

18. The enclosure assembly of claim 17, wherein the range of motion is up to approximately 60 degrees.

19. The enclosure assembly of claim 17, wherein the second bracket includes an arm that defines the channel and slidably supports the at least one support plate between the second bracket and the mounting bracket.

20. The enclosure assembly of claim 17, wherein the first bracket includes a first slot defined by the first side wall and a second slot defined by the second side wall, the first slot and the second slot extending in a direction perpendicular to the axis, the first slot and the second slot configured to receive the plurality of retention members to allow positional adjustment of the first bracket relative to the second bracket in the direction perpendicular to the axis.
